(19) United States
(12) Patent Application Publication
(10) Pub. No.: US 2013/0193755 A1
(43) Pub. Date: Aug. 1, 2013

(54) LOAD BALANCED SPLIT-PHASE MODULATION AND HARMONIC CONTROL OF DC-DC CONVERTER PAIR/COLUMN FOR REDUCED EMI AND SMALLER EMI FILTERS

(71) Applicants: Jie Jay Chang, Newbury Park, CA (US); Bhuvan Govindasamy, Rancho Santa Margarita, CA (US)

(72) Inventors: Jie Jay Chang, Newbury Park, CA (US); Bhuvan Govindasamy, Rancho Santa Margarita, CA (US)

(73) Assignee: Eaton Corporation, Cleveland, OH (US)

(21) Appl. No.: 13/360,951

(22) Filed: Jan. 30, 2012

(51) Int. Cl. H02J 1/10

(52) U.S. Cl. 307/18

(57) ABSTRACT

A novel circuit scheme and control includes a plurality of identical DC-DC converters with an optimal modulation/harmonic controller and a load balancing portion or process in an integral and systematic design methodology. The modulation/harmonic controller can be configured to control the individual modules in an optimal and coordinated way in the time domain so as to substantially reduce or eliminate a large amount of high-frequency input current harmonics, thus reducing EMI, weight, and size and increasing redundancy. The load balancing portion or process can balance the loads on the converters in real time or offline.

### BACKGROUND

1. Technical Field

The present disclosure relates to the supply, regulation, and conversion of power, including the supply, regulation, conversion, and reduction of electromagnetic interference (EMI) for a direct current (DC) power converter for aircraft, vehicle and telecommunications applications.

2. Description of the Related Art

Most DC-DC converters and power supplies operate in isolation—i.e., a single-converter circuit operates independently of other converters. For example, a single Buck converter, or its variation, employs only a single internal power-switching device (referred to as modular level N=1). Systematic, coordinated control at the system level for multiple Buck converters may improve the output voltage waveform over non-coordinated control. For example, a circuit connection topology may be provided with parallel connections of the output power terminals of multiple individual converter cells to organize the output voltage waveforms from the individual Buck converter units with a proper phase arrangement to reduce the output-voltage ripple. However, the state of the art is limited with respect to the improvement of converter input waveforms and does not include parallel connections and coordinated operations at the input terminals of multiple converters. Thus, known converters may not address issues such as electromagnetic interference (EMI) and electromagnetic compatibility (EMC) on the input side. As a result, known arrangements must employ large and heavy EMI filters to attenuate undesirable harmonics and electromagnetic interference at the converter input ports, or else the converters produce a significant amount of undesirable conductive and radiated emissions that are proportional to the load power/current level. Such large EMI filters, which add significant weight and bulk to the power supply, are undesirable for many applications, including aerospace applications.

### SUMMARY

Many industries, such as aerospace and telecommunications, have imposed rigorous regulatory standards/requirements for EMI and EMC on the power converter's input side, where EMI is more likely to interfere with other users/equipments sharing the same power input bus. The regulations generally include both radiated and conducted emissions and cover a wide frequency range of over 30 MHz.

The present disclosure describes new systems for advanced control, modular configuration and optimal cross-module modulation of multiple converter cells. The circuit topology of this new scheme may include parallel connections at the input power terminals of each individual converter cell, but may have no direct parallel connections in the output side (i.e., isolated outputs). Control and modulation of the multiple converter cells may include coordinated split-phase and/or multiple-phase modulation with an additional load balancing scheme or stage. Such a control and modulation scheme enables reduction of the input harmonics at the input port of the DC-DC power converters and enables EMI cancellation (or significant reduction) at the core circuit of power switching, where the EMI noise sources are located.

To illustrate the basic principle, the disclosure starts from a very basic scheme that employs two identical core circuits of DC-DC converters (modular level N=2), but uses a phase-angle-differential modulation of 180 electric degrees with a novel load current balancing configuration. The novel load current balancing design embedded together with the load matching or management allows the two converters to operate close to a 50% duty cycle in most nominal steady-state operations. As a result, the total input current to the converters can be a smooth DC current, rather than a square-wave pulsating current. This simplified example shows that the techniques of this disclosure can effectively reduce input current pulsation, thus reducing the rapid transient components in the input current and reducing transient current induced EMI. In addition, the approach of this disclosure also facilitates EMI cancellation in the main input current paths by a top-bottom pair layout of the PCB traces in the respective DC-DC converters.

A more in-depth disclosure of load balanced, multiple-phase modulation and a modular circuit scheme for low-EMI DC-DC conversion is further discussed in this disclosure at a modular level N=3. Quantitative theoretical analysis, digital simulation and initial experimental results have shown that this can effectively and significantly reduce input harmonic currents and improve EMI reduction at all load conditions. Further, multiple-phase modulation and a modular circuit scheme for low-EMI DC-DC conversion is further disclosed for a modular level N=k, where k>1 and k is an integer.

In an embodiment, a power conversion circuit providing the above-noted advantages may include two or more direct current to direct current (DC-DC) converters and a load-balancing circuit portion. The converters may be configured to receive input power from two or more input power sources, and further configured to be modulated with an electrical signal phase differential relative to one another. The load balancing circuit portion may be coupled with respective outputs of the DC-DC converters and configured to balance the respective loads on the DC-DC converters with each other.

In an embodiment, the power conversion circuit may further include an EMI filter coupled with the power sources and with the input of the DC-DC converters. The EMI filter may include two, or more, channels. Each channel can be configured to receive input power through a respective power bus.

Another embodiment of a power conversion circuit providing the above-noted advantages may include a DC converter group comprising a plurality of DC-DC converter cells and parallel input power terminal connections for two or more of the individual converter cells in the converter group, wherein the output terminals of the individual converter cells are isolated from each other. The circuit may further include a multiple-phase modulation controller coupled with the DC converter group and a load balancing circuit portion, the load balancing circuit portion coupled with respective outputs of the DC-DC converters, and configured to balance the respective loads on the DC-DC converters with each other.

Still another embodiment of a power conversion circuit providing the above-noted advantages may include an electromagnetic interference (EMI) filter column configured to be coupled with an input power source, two or more direct current to direct current (DC-DC) converters coupled with the output of the EMI filter column, and a modulation controller. The modulation controller may be coupled with the DC-DC converters and may be configured to modulate the DC-DC converters with phase angle differential modulation wherein the relative electrical signal phase differential between two of the DC-DC converters is inversely proportional to the number of converters that are modulated together.

More disclosures are given in the following sections and Figures:

### BRIEF DESCRIPTION OF THE DRAWINGS

Embodiments of the invention will now be described, by way of example, with reference to the accompanying drawings, wherein:

FIG. 1 is a block diagram view of an embodiment of a power conversion circuit including a DC converter column (dual cell) applying a load balanced, split-phase modulation scheme.

FIG. 2 is a block diagram view of an embodiment of a power conversion circuit scheme including a DC converter column (dual cell) with control compensation for load balancing and split-phase modulation.

FIG. 3 is a block diagram view of an embodiment of a power conversion circuit including a load balanced multiple cell converter column with coordinated cross-cell control of a split-phase modulation scheme.

FIG. 4 is a schematic and block diagram view of an exemplary embodiment of a multiple-phase modulation and modular circuit scheme for an aircraft cockpit control panel illumination and LED load application.

FIG. 5 is a schematic view of an exemplary embodiment of an individual converter cell.

FIGS. 6A-6C are plots illustrating theoretical input current waveforms for exemplary embodiments of modulation schemes for a single DC-DC converter (N=1) with a single switch, at duty cycles of D=⅓, D=⅔ and D=⅔, respectively.

FIGS. 7A-7B are plots illustrating theoretical input current waveforms for exemplary embodiments of split-phase modulation schemes for three DC-DC converters (N=3), with a single switch, at duty cycles of D=⅓ and D=⅔, respectively.

FIGS. 8A-8B are plots illustrating theoretical input current waveforms for exemplary embodiments of split-phase modulation schemes for three DC-DC converters (N=3) at duty cycles of D=½ and D=⅚, respectively.

FIGS. 9A-9B are plots illustrating theoretical input current frequency spectra for exemplary embodiments of split-phase modulation schemes at a duty cycle of D=½ for three DC-DC converters (N=3) and one DC-DC converter (N=1), respectively.

### DETAILED DESCRIPTION

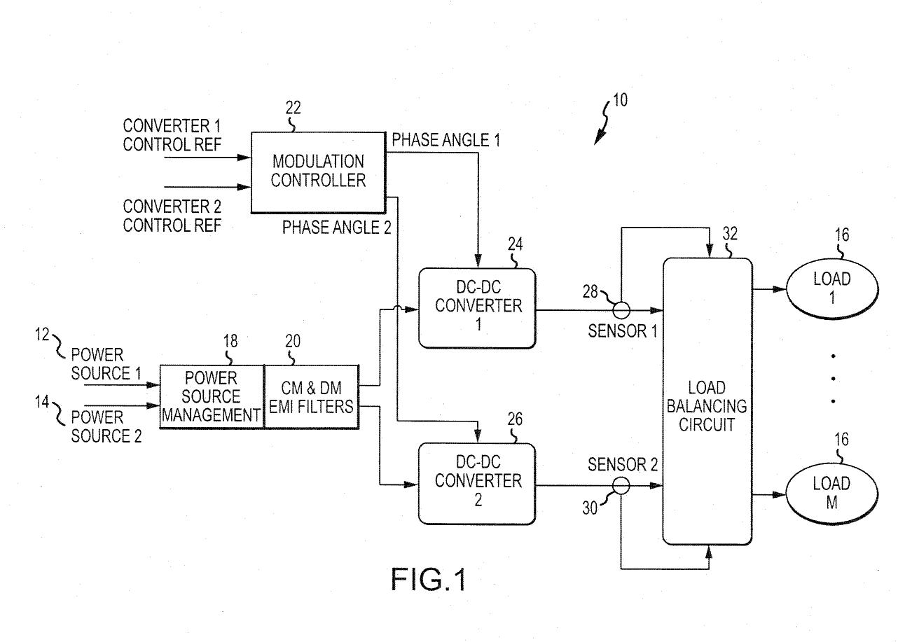

FIG. 1 is a block diagram view of an embodiment of a power conversion circuit 10. The circuit 10 receives input power from a first power source 12 and a second power source 14, and the circuit output is coupled to a plurality of loads 16. The illustrated circuit 10 includes a power source management portion 18, which itself includes an electromagnetic interference (EMI) filter 20, a modulation controller 22, two direct current to direct current (DC-DC) converters 24, 26, two sensors 28, 30, and a load balancing portion 32.

The power source management portion 18 of the circuit 10 is coupled to both input power sources 12, 14. In an embodiment, the EMI filter 20 is coupled directly to both input power sources 12, 14. The power source management portion 18 and the EMI filter 20 may comprise conventional components and topologies known in the art.

The DC-DC converters 24, 26 are coupled to the output of the power source management portion 18 of the circuit and, in an embodiment, coupled to the output of the EMI filter 20. Both of the DC-DC converters 24, 26 may comprise conventional components known in the art and, in an embodiment, may be identical to each other. The DC-DC converters 24, 26 may be configured to increase or decrease the voltage from their input side (i.e., power sources 12, 14) to their output side (i.e., loads 16). In an aircraft embodiment in which the power management circuit 10 is used to provide power from a main aircraft power bus to an instrument panel, light dimming controller, or other system, the DC-DC converters 24, 26 may change voltage from input to output. For example, the power sources 12, 14 may provide input power at 28V, and the DC-DC converters 24, 26 may decrease the voltage to 24V for the loads 16.

The modulation controller 22 may be coupled to both of the DC-DC converters 24, 26 and may provide a modulation signal for each converter. In an embodiment, the modulation controller 22 applies a “split-phase” modulation scheme in which the converters 24, 26 are modulated approximately 180 electrical degrees out of phase with each other. To do so, the modulation controller may provide separate modulation signals to the converters that have a relative phase differential of 180 degrees. The underlying modulation scheme to which the phase differential is applied may be a scheme known in the art (e.g., pulse-width modulation). The modulation controller 22 may adjust the modulation scheme and the phase differential in the respective modulation signals for the DC-DC converters 24, 26 according to respective modulation control reference signals. The respective reference signals may be related to the output of the converters or to a signal present at an intermediate stage of the converters.

The load balancing portion 32 of the circuit 10 may be coupled to the output of the converters 24, 26 and may distribute power to loads 16 such that the load on (i.e., the power provided by) each of the converters 24, 26 is approximately equal. The load balancing portion 32 may receive additional input from sensors 28, 30 indicative of respective output characteristics (e.g., power, voltage, current) of the converters 24, 26 and may distribute power accordingly. In general, the load balancing can be achieved in real time (i.e., “on-line”) by a load managing/balancing circuit, or in an off-line load balancing/management process, or with both. The connection topology illustrated in FIG. 1 allows multiple output voltage levels for different loads having different voltage ratings while balancing each output power to be approximately equal.

The topology of the power conversion circuit 10 can provide advantages over power supplies and power conversion circuits and topologies known in the art. For example, without limitation, by applying a split-phase modulation scheme to the converters 24, 26 and balancing the loads on the converters 24, 26, the circuit 10 can reduce the input current pulsation and EMI—both conductive and radiated—produced at the input. As a result, the EMI filter 20 can then be constructed to be comparatively smaller than in known circuits, allowing for a smaller, lighter and less expensive circuit. Moreover, the combination of split-phase modulation and load balancing can permit the converters 24, 26 to operate close to a 50% duty cycle in most nominal steady-state operations. As a result, the input current pulsation may be reduced further and the power quality can be improved for loads connected to the power sources 12, 14. In a further embodiment, the circuit 10 can be laid out in a top-bottom pair configuration on a printed circuit board (PCB). A top-bottom PCB layout can further reduce EMI at the input of the circuit.

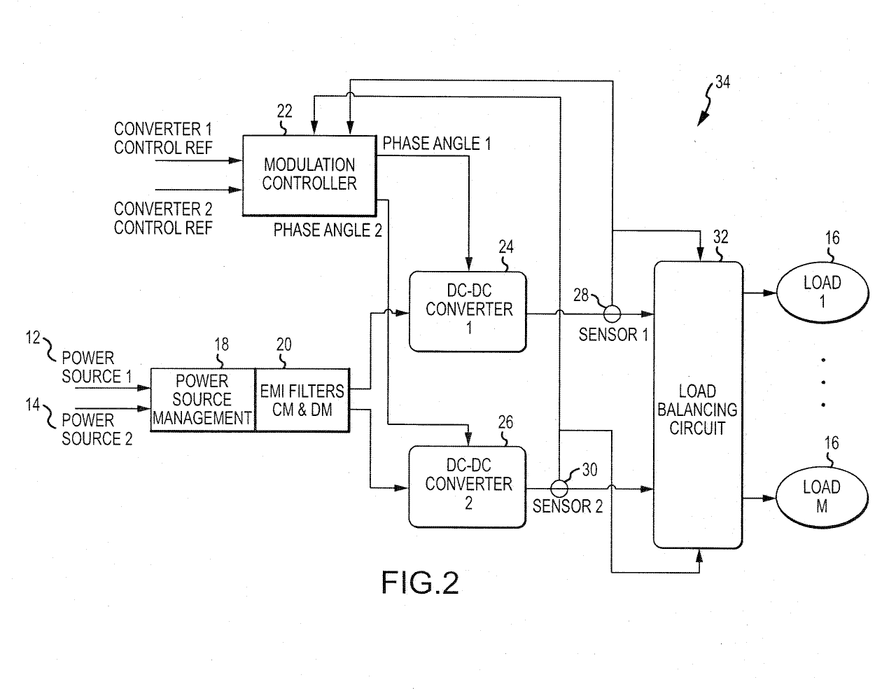

FIG. 2 is a block diagram view of another embodiment of a power conversion circuit 34. The illustrated power conversion circuit 34 generally includes the same or similar components and electrical connections as the previously illustrated circuit 10, but may provide additional load balancing functionality. In power conversion circuit 34, sensors 28, 30 may be additionally electrically coupled to modulation controller 22. The modulation controller 22 can use the information provided by the sensors 28, 30 to adjust the modulation signals for the DC-DC converters 24, 26, at a small signal mode. By adjusting the modulation signals (while still modulating the converters, e.g., approximately 180 degrees out-of-phase with each other), the modulation controller 22 can further balance the respective loads on the converters 24, 26.

The topology and control scheme described above can be extended to a higher number of modular level N=k, where k>1 and k is an integer. As illustrated and discussed below, quantitative theoretic analysis, digital simulation and initial experimental results have shown that this can effectively and significantly reduce the input harmonic currents and benefit EMI reduction at all load conditions.

The load-balanced modulation scheme illustrated in FIGS. 1-2 may be applied to higher modular levels (i.e., a greater number of converter cells), such as N=3.

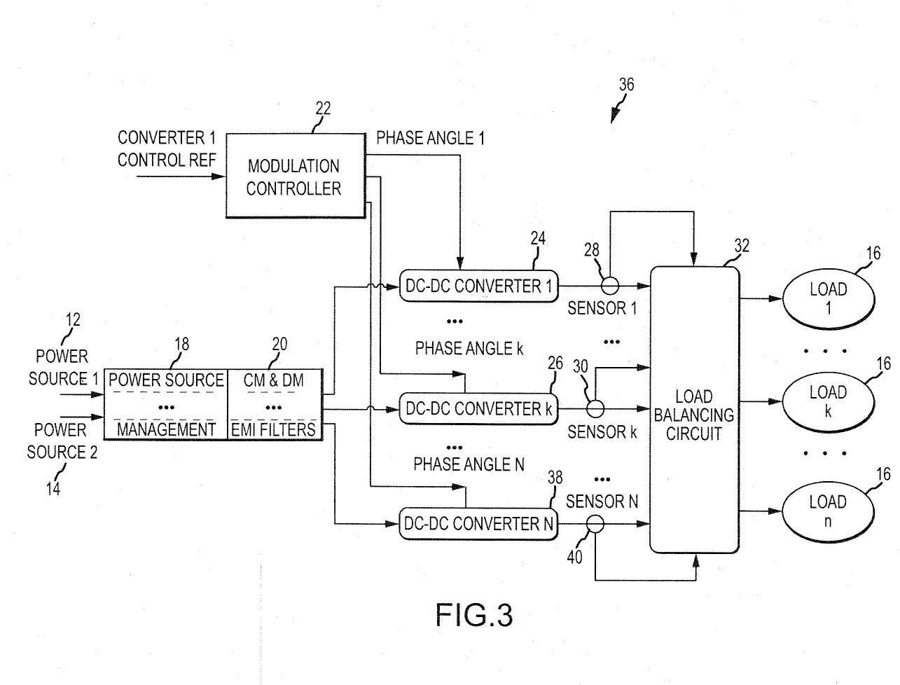

FIG. 3 is a block diagram view of yet another embodiment of a power conversion circuit 36 which generally illustrates the scalability of both of the previously-illustrated circuits 10, 34. The circuit 36 generally includes many of the same or similar components and electrical connections as the previous circuits 10, 34, but with additional converter channels. The circuit 36 includes a plurality N of DC-DC converters, with three such converters 24, 26, 38 shown. The circuit 36 also includes a plurality N of sensors, with three such sensors 28, 30, 40, shown, and N loads 16. The number N may be customized to suit a particular application. Although N loads are shown, the number of loads can be different from the number of converter channels.

Each element in the circuit 36 can be scaled to accommodate any number N of DC-DC converters. Power source management portion 18 and EMI filter 20 may each have a channel for each DC-DC converter, each of the N DC-DC converters may have an associated sensor, and the load balancing circuit portion 32 may be configured to distribute power from N converters to the loads 16 according to input from the N sensors.

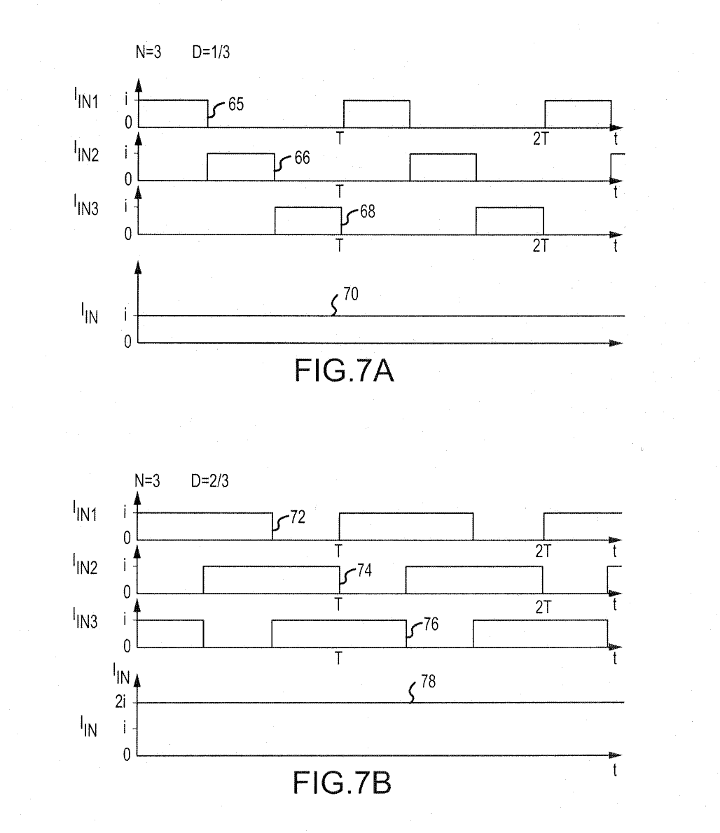

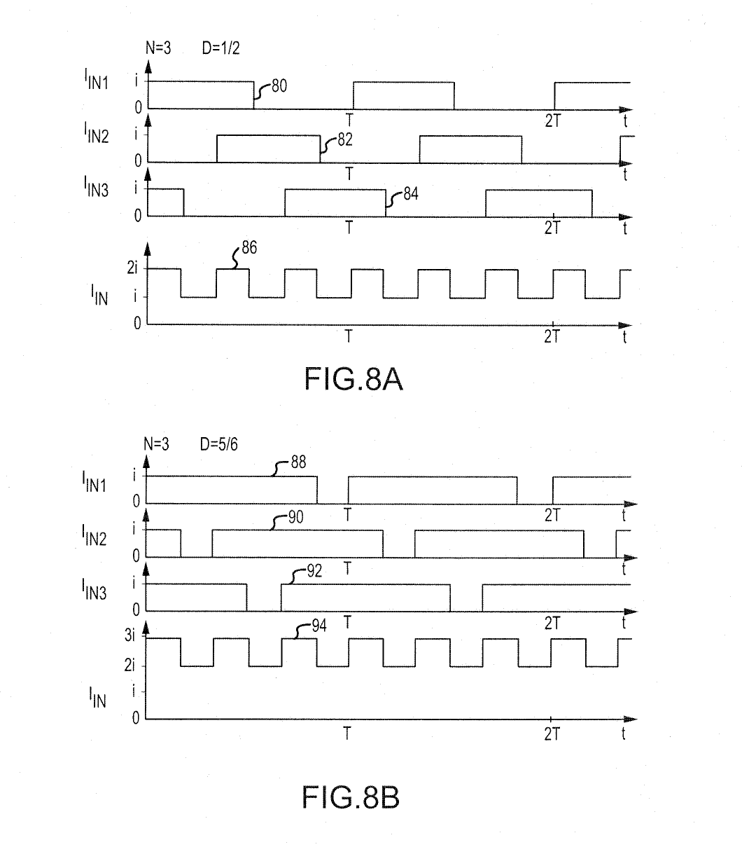

The modulation controller 22 also can be scaled to provide N modulation signals—i.e., a separate modulation signal for each of the N converters 24, 26, 38. In an embodiment including more than two such converters, the phase angle differential between converters may be inversely proportional or otherwise related to the number of converters that are modulated together. For example only, in an embodiment, the phase angle differential θ (in degrees) between the first converter 24 and each other converter k may be calculated approximately according to equation (1) below:

$${θ}_{k} = - 180 ( \frac{k - 1}{N} ) \qquad ( Eq . 1 )$$

Where k=1, . . . , N. In such an embodiment, the relative phase angle differentials may be evenly distributed among the several converters, as illustrated in FIGS. 7A-7B and 8A-8B. In another embodiment, the relative phase angle differential between converters may follow another pattern or scheme.

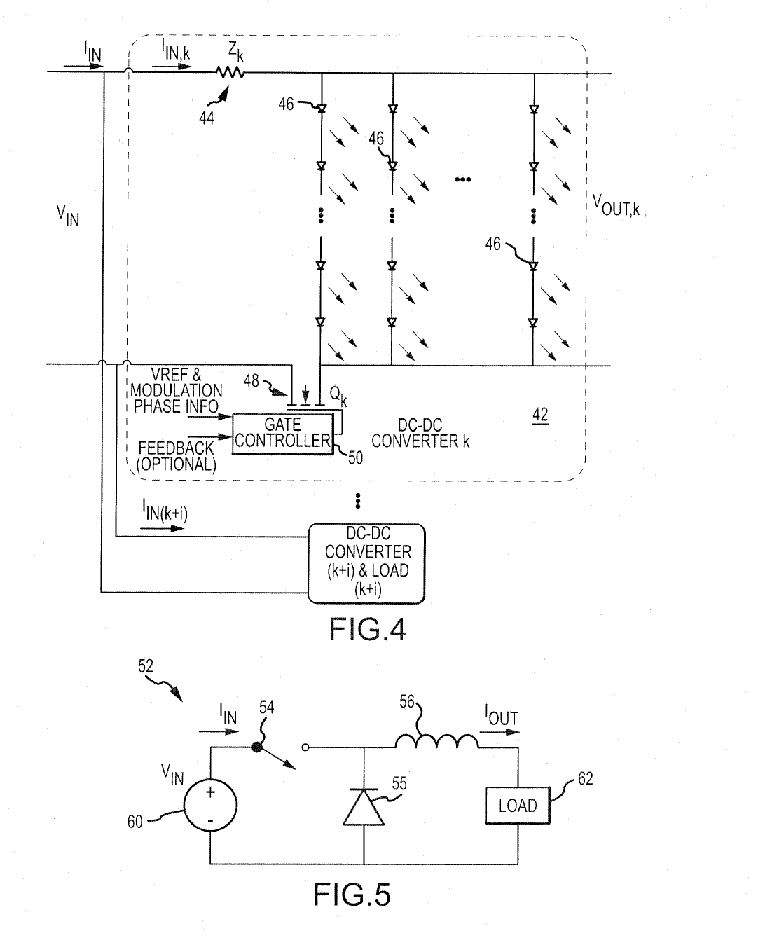

FIG. 4 is a schematic and block diagram view of an exemplary embodiment of a DC-DC converter 42 that may find use in one of the systems 10, 34, 36. The converter 42 includes an input resistance 44, and plurality of light-emitting diodes (LEDs) 46, a switch device (transistor or MOSFET) 48 for voltage modulation, and a gate controller 50. For ease of illustration, not all diodes 46 are labeled. The input resistance 44 and LEDs 46 comprise the load on the converter 42.

Under the control of the gate controller 50, the transistor 48 may switch on and off to modulate the load voltage of converter 42. The gate controller 50 may apply a modulation scheme as known in the art such as, for example only, pulse-width modulation. Reference signals and modulation phase information may be provided by a central controller (e.g., modulation controller 22 generally illustrated in FIGS. 1-3).

The converter 42 can be one in a series of many DC-DC converters operated in parallel, as illustrated by DC-DC converter k+i. The converter 42 can be configured to share a common input current I_{IN} and a common input voltage V_{IN} with other converters. And as described in conjunction with FIGS. 1-3, the converter 42 and other converters can be modulated according to a common scheme (e.g., split-phase modulation) to provide a high-quality power interface.

FIG. 5 is a schematic and block diagram view of another exemplary embodiment of a DC-DC power converter 52 that may find use in one of the systems 10, 34, 36. The converter 52 is a buck converter including a switch 54, a diode 55, and an inductor 56. The input of the converter is coupled with a power supply 60, and the output of the converter is coupled with a load 62.

The operation of a buck converter is well known in the art as a step-down converter with an output voltage that is lower than its input voltage, however, a further description follows. The switch 54 cyclically opens and closes to modulate the converter. For example, the switch 54 can open and close under the direction of a modulation controller. When the switch 54 is closed, the diode 55 is reverse-biased and acts nearly as an open switch. When the switch 54 opens, the diode 55 is forward-biased and acts as a closed switch. The output voltage may be proportional to the amount of time that the switch 54 is closed in each open-close cycle.

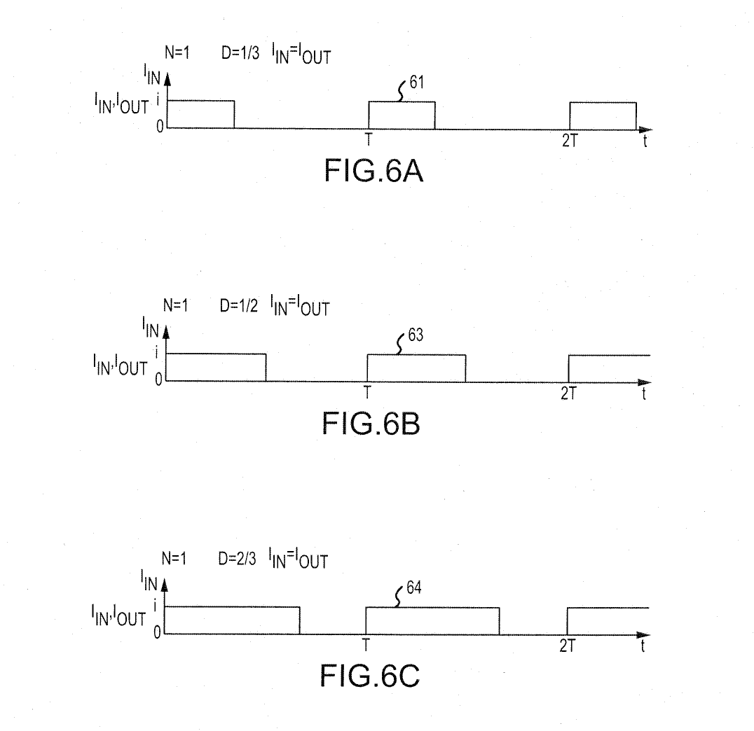

FIGS. 6A-6C are plots generally illustrating exemplary embodiments of input waveforms for a single DC-DC converter, such as one of the converters 24, 26, 38, 42, 52 shown in FIGS. 1-5. FIG. 6A includes a waveform 61 illustrating an input current when the converter is operated at a duty cycle of ⅓. FIG. 6B includes a waveform 63 illustrating an input current when the converter is operated at a duty cycle of ½. FIG. 6C includes a waveform 64 illustrating an input current when the converter is operated at a duty cycle of ⅔. As used herein and as known in the art, “duty cycle” refers to the amount of time in a period T that the current in the converter is on—e.g., the amount of time that the modulation switch is closed—as a proportion of the period T. That is, for a duty cycle of ½, the modulation switch is closed for half of the period T, and for a duty cycle of ⅔, the modulation switch is closed twice as long as it is open for each period T. As shown in FIG. 6, the conventional converter (such as those shown in FIG. 5) must switch (pulse) the input current between 0 and 100% of the output current level at a frequency fs=1/T.

FIGS. 7A and 7B are plots generally illustrating exemplary embodiments of input current waveforms for three DC-DC converters modulated with a split-phase modulation scheme. FIG. 7A includes three waveforms 65, 66, 68 illustrating respective input currents for three respective DC-DC converters and a waveform 70 illustrating the total input current at the power input port (bus) connected to all three converters. As shown in FIG. 7A, the three converters may be operated at a duty cycle of ⅓ with phase angles distributed according to Equation (1). This combination of duty cycle and phase splitting can result in a pulsation-free input (bus) current.

FIG. 7B includes three waveforms 72, 74, 76 generally illustrating respective input currents for three respective DC-DC converters and a waveform 78 illustrating a total input current in a bus connected to all three converters. As in FIG. 7A, the three converters have phase angle distributions according to Equation (1), but operate at a duty cycle of ⅔. As a result, the current is pulsation-free, but is twice as high as the input current amplitude for each converter and, thus, twice as high as the current resulting from a duty cycle of ⅓ shown in FIG. 7A.

FIGS. 8A-8B are plots generally illustrating exemplary embodiments of input current waveforms for three DC-DC converters on a common power bus modulated with a split-phase modulation scheme.

FIG. 8A includes three waveforms 80, 82, 84 illustrating respective input currents for three respective DC-DC converters and a waveform 86 illustrating the total input current in a bus connected to all three converters. The three converters are operated at a duty cycle of ½ with phase angles distributed according to Equation (1). This combination of duty cycle and phase splitting results in a pulsating total input current that alternates between a first current level that is equal to the input current amplitude for each converter and a second current level that is twice as high as the input current amplitude for each converter.

As shown in waveform 86 in FIG. 8A (N=3 and D=½), the total input current is composed of a DC component at a level of i and an AC component superimposed on the DC component. The amplitude of the AC component is ½ of the ceiling value of the total input current (2i), while the pulsation period is decreased to ⅓ of T. Further, in comparison with waveform 62 in FIG. 6B (N=1 and D=½), the amplitude of the input current pulsation of waveform 86 is reduced by 50% while the frequency of the AC current pulsation is increase to 3 times fs (3×fs).

FIG. 8B includes three waveforms 88, 90, 92 illustrating respective input currents for three respective DC-DC converters and a waveform 94 (N=3 and D=⅚) illustrating the total input current for a bus connected to all three converters. The three converters are operated at a duty cycle of ⅚ with phase angles distributed according to Equation (1). This combination of duty cycle and phase splitting results in a pulsating current that alternates between a first current level of 2i that is twice as high as the input current amplitude for each converter and a second current level 3i that is three times as high as the input current amplitude for each converter. The DC component of the current is increased to a level of 2i, while the amplitude of the AC component is ⅓ of the ceiling value of the input current. In contrast, a conventional converter must switch (pulse) the input current between 0 and 100% of the output level, as shown in FIG. 6C. The frequency of the AC current pulsation remains at 3 times fs (3×fs).

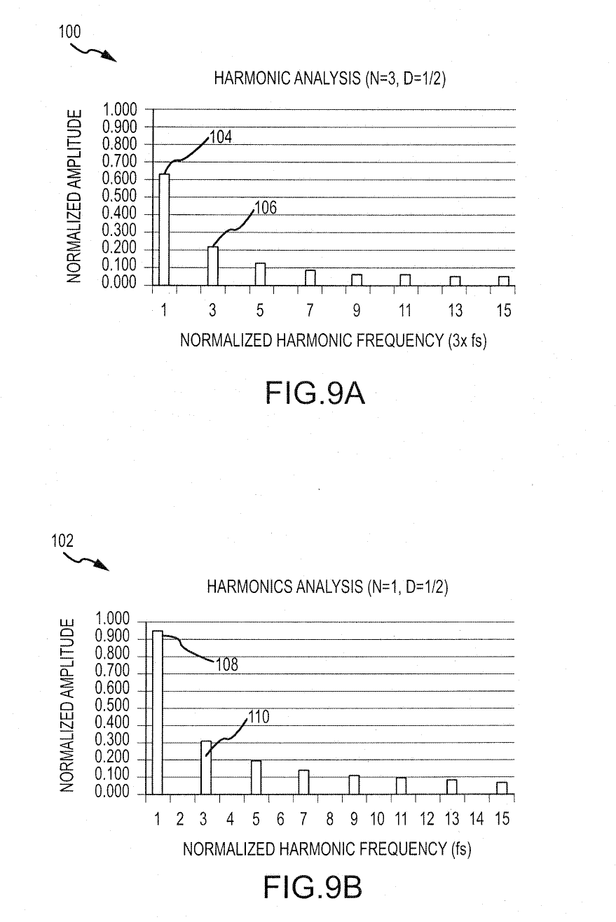

FIGS. 9A-9B further illustrate the characteristics of the proposed circuit in the frequency domain by illustrating a comparative Fourier analysis of the waveform 86 in FIG. 8A (N=3 and D=½) and the waveform 62 in FIG. 6B (N=1 and D=½). In FIGS. 9A-9B, the current and frequency are normalized and calibrated to an equivalent output current level.

As shown in FIG. 9A, increasing the modular level of the system from N=1 to N=3 increases the frequency of the first order harmonic 104 to 3×fs (as compared to fs, shown for the first order harmonic 108 in FIG. 9B) and the second available harmonic 106 (3rd order) to 3'3 fs=9 fs (as compared to fs, as shown for the third order harmonic 110 in FIG. 9B). In fact, all harmonic frequencies are shifted by a factor of 3 in the frequency axis in comparison to FIG. 9B, which illustrates a conventional single converter scheme. In addition, the amplitude of each harmonic in FIG. 9A is significantly reduced in comparison with its counterpart in the single-converter scheme shown in FIG. 9B. Thus, the present disclosure effectively improves the harmonics control of the input current and significantly improves EMI noise reduction, thus reducing the weight and size of EMI filters and the overall converter.

The drawings are intended to illustrate various concepts associated with the disclosure and are not intended to so narrowly limit the invention. A wide range of changes and modifications to the embodiments described above will be apparent to those skilled in the art, and are contemplated. It is therefore intended that the foregoing detailed description be regarded as illustrative rather than limiting, and that it be understood that the following claims, including all equivalents, are intended to define the spirit and scope of this invention.

What is claimed:

1. A power conversion circuit comprising:
two or more direct current to direct current (DC-DC) converters, the converters configured to receive input power from two or more input power sources, and further configured to be modulated with an electrical signal phase differential relative to one another; and
a load balancing circuit portion, the load balancing circuit portion coupled with respective outputs of the DC-DC converters, and configured to balance the respective loads on the DC-DC converters with each other.

2. The power conversion circuit of claim 1, further comprising a first sensor coupled with the output of one of the DC-DC converters and a second sensor coupled with the output of another DC-DC converter, both sensors being further coupled with the load balancing circuit.

3. The power conversion circuit of claim 1, further comprising a modulation controller coupled to at least two of the two or more DC-DC converters, the modulation controller configured to modulate two DC-DC converters with a relative electrical signal phase differential.

4. The power conversion circuit of claim 3, wherein the modulation controller is further configured to provide feedback of the respective outputs of the DC-DC converters.

5. The power conversion circuit of claim 4, wherein the modulation controller is configured to adjust the modulation of the DC-DC converters with respect to the output of the DC-DC converters.

6. The power conversion circuit of claim 1, wherein the relative electrical signal phase differential between two of the DC-DC converters is inversely proportional to the number of converters that are modulated together.

7. The power conversion circuit of claim 1, further comprising an electromagnetic interference (EMI) filter having an input and an output, the filter output coupled with the input of the DC-DC converters and the filter input configured to be coupled with the two or more power sources.

8. A power conversion circuit comprising:
a DC converter group comprising a plurality of DC-DC converter cells;
parallel input power terminal connections for two or more of the individual converter cells in the converter group, wherein the output terminals of the individual converter cells are isolated from each other;
a multiple-phase modulation controller coupled with the DC converter group; and
a load balancing circuit portion, the load balancing circuit portion coupled with respective outputs of the DC-DC converters, and configured to balance the respective loads on the DC-DC converters with each other.

9. The power conversion circuit of claim 8, wherein said circuit is load balanced in an off-line design process.

10. The power conversion circuit of claim 8, wherein the relative electrical signal phase differential between two of the DC-DC converters is inversely proportional to the number of converters that are modulated together.

11. The power conversion circuit of claim 10, wherein said circuit comprises a number k of converter cells and the electrical signal phase differential is ±180/k degrees.

12. The power conversion circuit of claim 11, wherein the respective loads on the converter cells are balanced at substantially equal levels.

13. The power conversion circuit of claim 8, wherein the relative electrical signal phase differential between two DC-DC converters in the DC converter group is inversely proportional to the number of converters that are modulated together.

14. The power conversion circuit of claim 8, wherein the respective loads on the individual converter cells are balanced at substantially equal levels.

15. The power conversion circuit of claim 8, wherein the modulation controller is further configured to receive feedback with respect to the output of the DC converter group.

16. The power conversion circuit of claim 8, further comprising an electromagnetic interference (EMI) filter having an input and an output, the filter output coupled with the input of the DC-DC converters and the filter input configured to be coupled with one or more power sources.

17. A power conversion circuit comprising:
an electromagnetic interference (EMI) filter column configured to be coupled with an input power source;
two or more direct current to direct current (DC-DC) converters coupled with the output of the EMI filter column; and
a modulation controller, coupled with the DC-DC converters, configured to modulate the DC-DC converters with phase angle differential modulation wherein the relative electrical signal phase differential between two of the DC-DC converters is inversely proportional to the number of converters that are modulated together.

18. The power conversion circuit of claim 17, further comprising a load balancing circuit, disposed between one or more loads and the output of the DC-DC converters, configured to balance the respective loads on the DC-DC converters with each other.

19. The power conversion circuit of claim 17, wherein the EMI filter column comprises two or more input EMI filter channels, each filter channel connected to a common input power DC bus.

20. The power conversion circuit of claim 19, wherein each filter channel is configured to be coupled with a respective one of the DC-DC converters during nominal operation.
